(19) United States
(12) Patent Application Publication
(10) Pub. No.: US 2012/0011483 A1
(43) Pub. Date: Jan. 12, 2012

(54) METHOD OF CHARACTERIZING REGULAR ELECTRONIC CIRCUITS

(75) Inventors: Alexander Y. Tetelbaum, Hayward, CA (US); Lun Ye, Bridgewater, NJ (US)

(73) Assignee: LSI Corporation, Milpitas, CA (US)

(21) Appl. No.: 12/830,840

(22) Filed: Jul. 6, 2010

(51) Int. Cl. G06F 17/50

(52) U.S. Cl. 716/113

(57) ABSTRACT

A methods of characterizing a regular electronic circuit and using a parameterized model of an electronic circuit to create a model for another electronic circuit. In one embodiment, the method of characterizing includes: (1) characterizing fewer than all sub-circuits associated with input and output pins of the circuit to yield data regarding the sub-circuits, (2) generating a data file containing the data, the data file constituting an expandable parameterized model of the circuit.

### TECHNICAL FIELD

This application is directed, in general, to electronic design automation (EDA) and, more specifically, to a method of characterizing regular electronic circuits.

### BACKGROUND

EDA tools, a category of computer aided design (CAD) tools, are used by electronic circuit designers to create representations of circuit configurations, including representations of cells (e.g., transistors) and the interconnects that couple them together. EDA tools allow designers to construct a circuit and simulate its performance using a computer and without requiring the costly and lengthy process of fabrication. EDA tools are indispensable for designing modern, very large-scale integrated circuits (VSLICs). For this reason, EDA tools are in wide use.

One type of EDA tool, an extraction tool, performs electric circuit extraction (or simply “extraction”), which is a translation of an IC layout back into the electrical circuit (“netlist”) it is intended to represent. Extracted circuits form the basis for characterization, in which parameterized models of the circuit are developed. Those models can then be used for various purposes, including simulation, static timing analysis (STA) and statistical timing analysis (SSTA). characterization is currently done either by characterizing an entire circuit or characterizing all of the input and output (I/O) pins of interest in the circuit. Unfortunately, characterizing complex electronic circuits using either of such techniques requires an immense number of calculations and a prohibitive amount of computer processing time and memory. Some regular circuits have proven to be too large to be characterized at all. Even assuming a particular circuit can be characterized, the resulting data (which constitutes a model of the circuit) may be too large to be stored efficiently. Further, the resulting data is rigid, rendering it unusable when a circuit of the same type, but different size, is considered.

### SUMMARY

One aspect provides a method of characterizing a regular electronic circuit. In one embodiment, the method includes: (1) characterizing fewer than all sub-circuits associated with input and output pins of the circuit to yield data regarding the sub-circuits, (2) generating a data file containing the data, the data file constituting an expandable parameterized model of the circuit.

Another aspect provides a data file constructed by the characterizing and the generating described above.

Yet another aspect provides a parameterized model and file format for containing a characterization of an electronic circuit. In one embodiment, the method includes: (1) a standard header and (2) data pertaining to characterizations of fewer than all sub-circuits associated with input and output pins of the circuit.

Still another aspect provides a method of using a parameterized model of an electronic circuit to create a model for another electronic circuit. In one embodiment, the method includes: (1) placing the parameterized model into a data file for the other circuit and (2) adding data to the data file corresponding to additional instances of sub-circuits characterized in the parameterized model and present in the other circuit.

### BRIEF DESCRIPTION

Reference is now made to the following descriptions taken in conjunction with the accompanying drawings, in which:

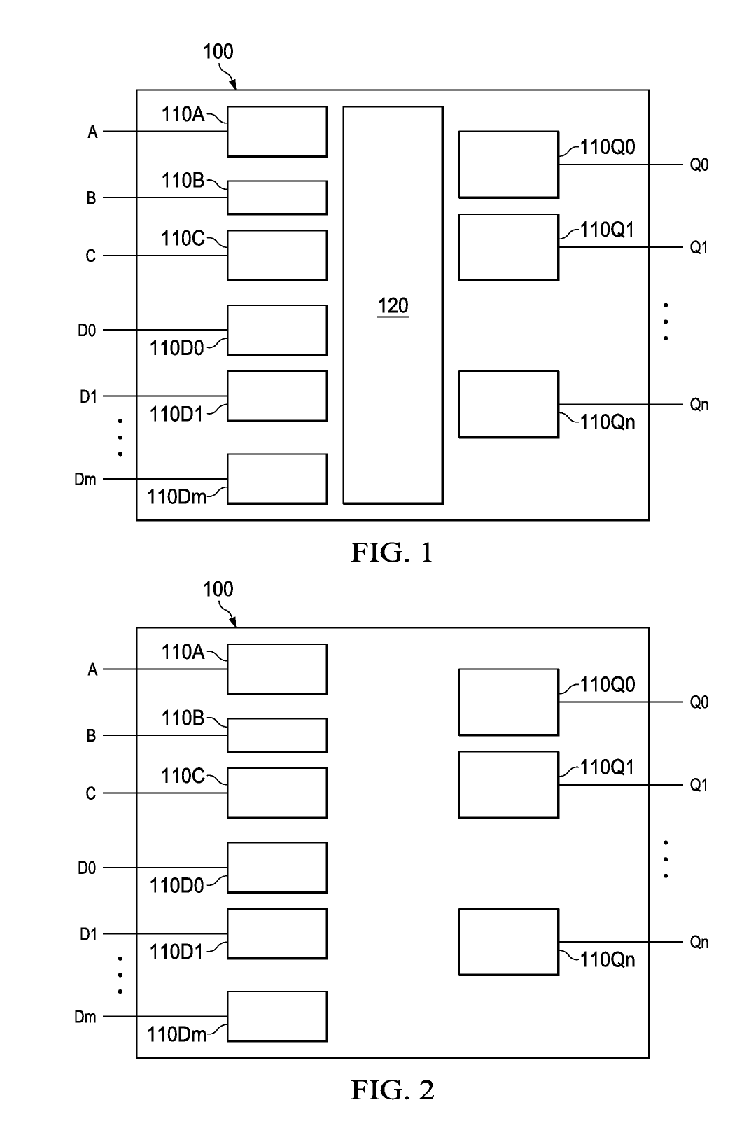

FIG. 1 is a schematic representation of an example of an electronic circuit for which the entire circuit is characterized;

FIG. 2 is a schematic representation of an example of an electronic circuit for which only I/O pins of the circuit are characterized;

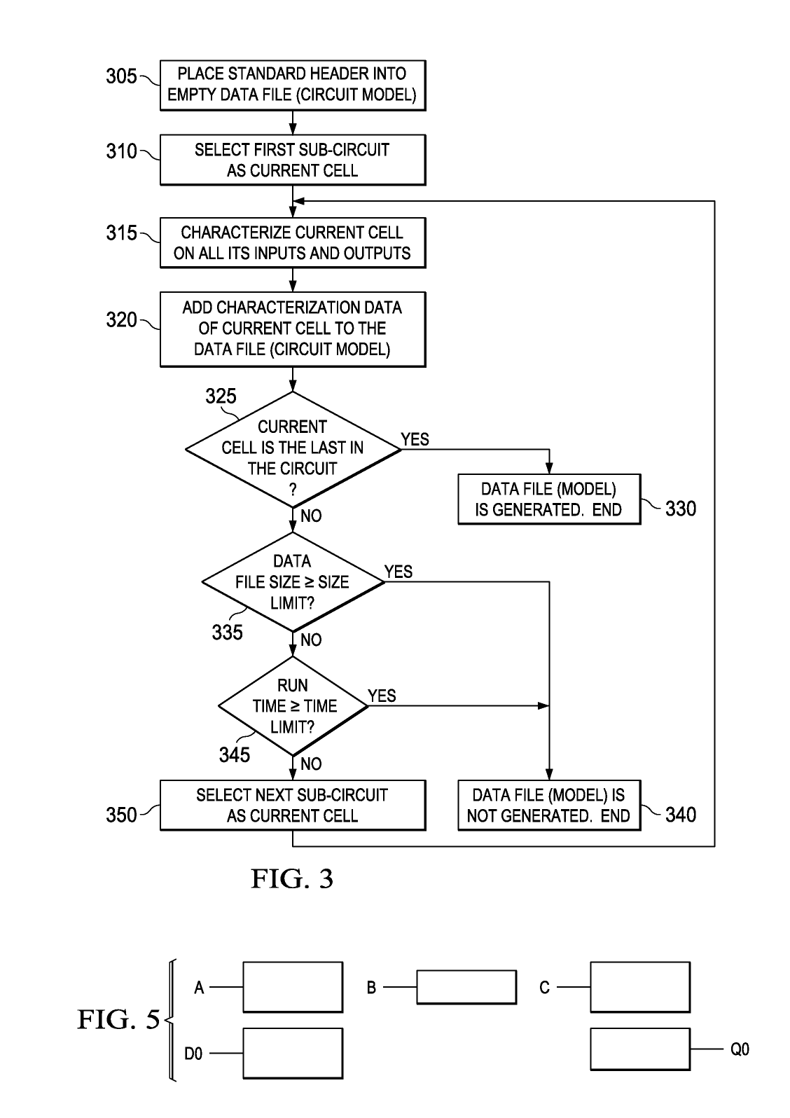

FIG. 3 is a flow diagram of one embodiment of a method of characterizing an entire circuit;

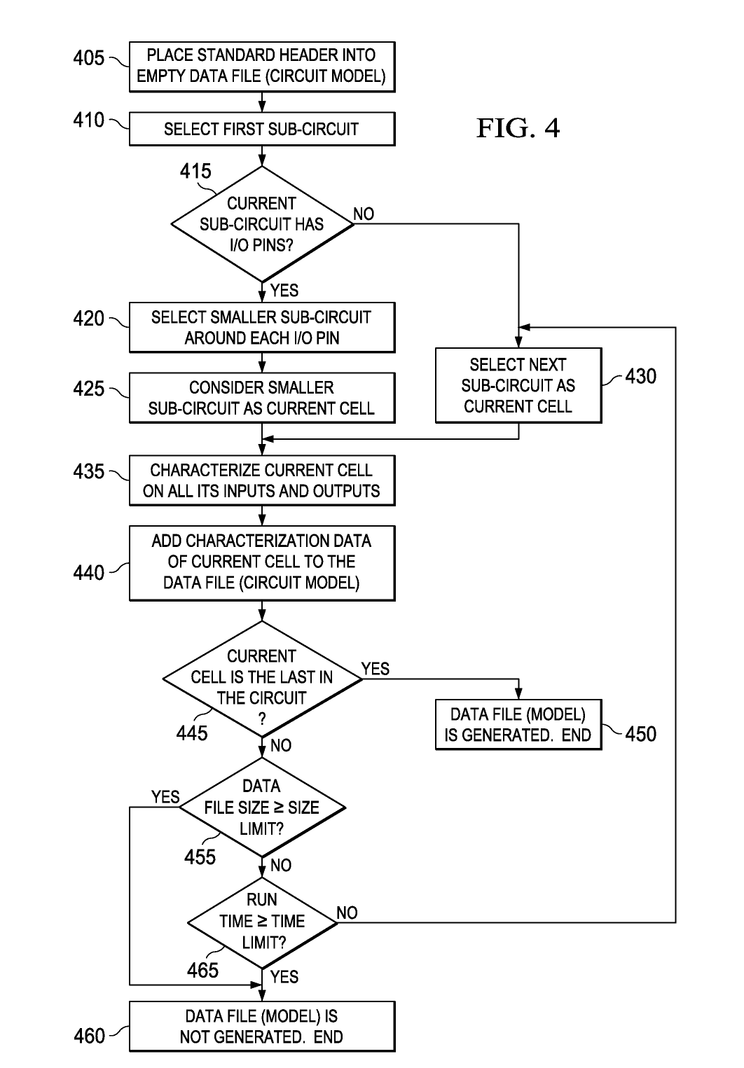

FIG. 4 is a flow diagram of one embodiment of a method of characterizing the input/output pins of interest of a circuit;

FIG. 5 is a schematic representation of an example of characterized unique circuits and pins that together constitute a model of a circuit;

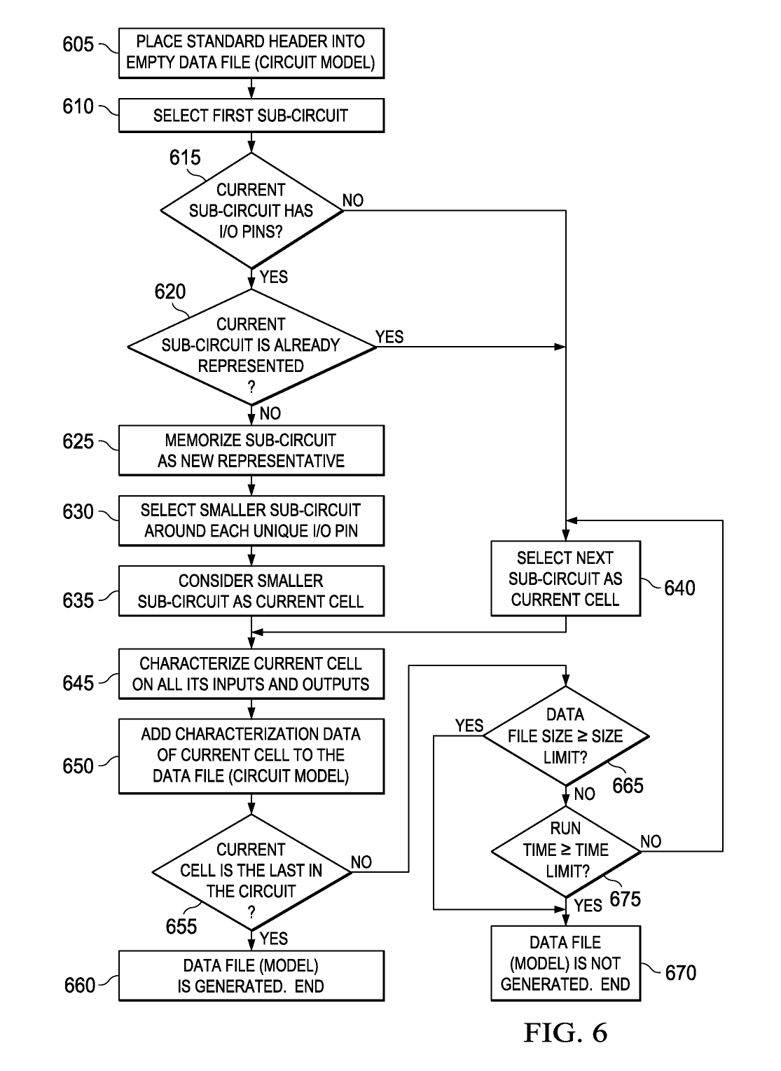

FIG. 6 is a flow diagram of another embodiment of a method of characterizing the input/output pins of interest of a circuit; and

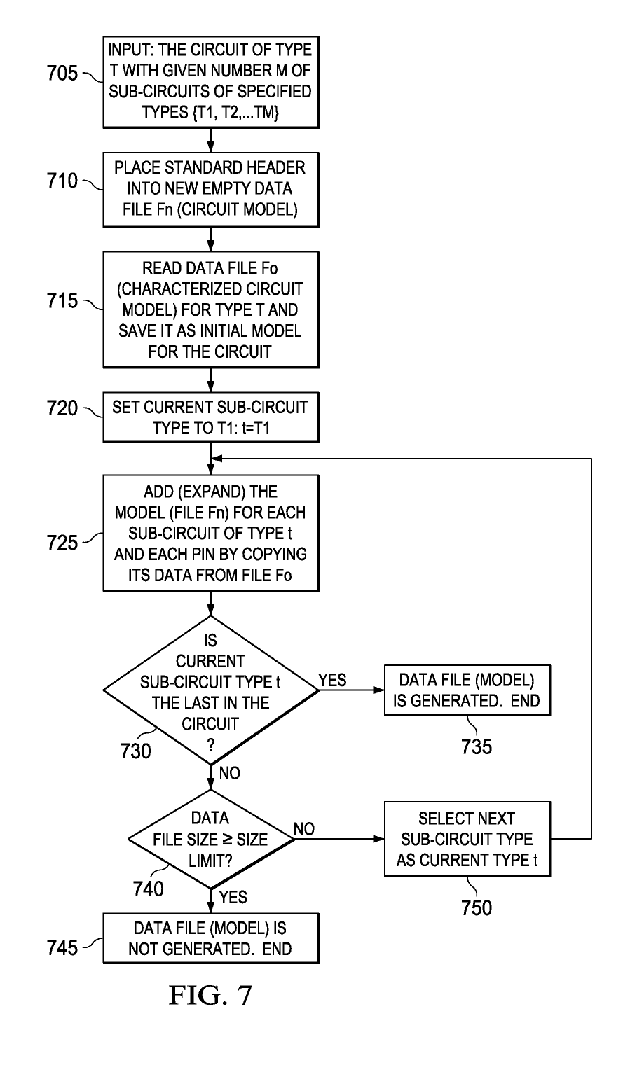

FIG. 7 is a flow diagram of one embodiment of a method of using a parameterized model and format to create a model for another circuit of the same type but not of the same dimension.

### DETAILED DESCRIPTION

Introduced herein are various embodiments of a method for characterizing regular electronic circuits, including those that are large and complex. More particularly introduced herein are various embodiments of generating a novel parameterized model and format for storing the parameterized model in computer memory. Further introduced herein are a method for using the model to create a model for another circuit of the same type but of different dimension. In certain embodiments, fewer than all I/O pins of a cell are characterized. In certain of those embodiments, only the unique I/O pins of a cell are characterized. In various embodiments, a model resulting from the characterization is then stored in computer memory (e.g., static or dynamic random-access memory, or on magnetic, optical, or magneto-optical media) in an expandable parameterized format. In certain embodiments, the model is then expanded in whole or in part to appropriate dimensions for either the characterized pins or other, similar pins. In one embodiment, characterizing is carried out one sub-circuit at a time in a single processor or a cooperating group of processors. In an alternative embodiment, sub-circuit characterization is carried out concurrently as individual tasks in parallel processors.

FIG. 1 is a schematic representation of an example of an electronic circuit 100 for which the entire circuit 100 is characterized. In the example of FIG. 1, the circuit 100 includes a memory block 120 (e.g., a block of dynamic random-access memory, or DRAM) and sub-circuits associated therewith. The circuit 100 has an I/O pin A coupled to a sub-circuit 110A, an I/O pin B coupled to a sub-circuit 110B, an I/O pin C coupled to a sub-circuit 110C, a data input (or “D-type”) pin D0 coupled to a sub-circuit 110D0, a D-type pin D1 coupled to a sub-circuit 110D1, a D-type pin Dm coupled to a sub-circuit 110Dm, a data output (or “Q-type”) pin Q0 coupled to a sub-circuit 110Q0, a Q-type pin Q1 coupled to a sub-circuit 110Q1 and a Q-type pin Qn coupled to a sub-circuit 110Qn. The D-type pins D0, D1, Dn, together with other D-type pins that may be present but are not shown in FIG. 1 cooperate to form an input data bus for the circuit 100. The Q-type pins Q0, Q1, Qn, together with other Q-type pins that may be present but are not shown in FIG. 1 cooperate to form an output data bus for the circuit 100. Accordingly, the sub-circuits 110D0, 110D1, 110Dm are identical, and the sub-circuits 110Q0, 110Q1, 110Qn are identical. The sub-circuits 110A, 110B, 110C are not only unique with respect to each other but also the sub-circuits 110D0, 110D1, 110Dm, 110Q0, 110Q1, 110Qn. FIG. 1 denotes this uniqueness by shading and sizing boxes representing the sub-circuits 110A, 110B, 110C, 110D0, 110D1, 110Dm, 110Q0, 110Q1, 110Qn accordingly. In the embodiment of FIG. 1, the memory block 120, together with the various sub-circuits 110A, 110B, 110C, 110D0, 110D1, 110Dm, 110Q0, 110Q1, 110Qn, is characterized.

FIG. 2 is a schematic representation of an example of an electronic circuit for which only I/O pins of the circuit are characterized. As with FIG. 1, the circuit 100 has an I/O pin A coupled to a sub-circuit 110A, an I/O pin B coupled to a sub-circuit 110B, an I/O pin C coupled to a sub-circuit 110C, a D-type pin D0 coupled to a sub-circuit 110D0, a D-type pin D1 coupled to a sub-circuit 110D1, a D-type pin Dn coupled to a sub-circuit 110Dm, a Q-type pin Q0 coupled to a sub-circuit 110Q0, a Q-type pin Q1 coupled to a sub-circuit 110Q1 and a Q-type pin Qn coupled to a sub-circuit 110Qn. The D-type pins D0, D1, Dn, together with other D-type pins that may be present but are not shown in FIG. 2 cooperate to form an input data bus for the circuit 100. The Q-type pins Q0, Q1, Qn, together with other Q-type pins that may be present but are not shown in FIG. 2 cooperate to form an output data bus for the circuit 100. Accordingly, the sub-circuits 110D0, 110D1, 110Dm are identical, and the sub-circuits 110Q0, 110Q1, 110Qn are identical. The sub-circuits 110A, 110B, 110C are not only unique with respect to each other but also the sub-circuits 110D0, 110D1, 110Dm, 110Q0, 110Q1, 110Qn. Like FIG. 1, FIG. 2 denotes this uniqueness by shading and sizing boxes representing the sub-circuits 110A, 110B, 110C, 110D0, 110D1, 110Dm, 110Q0, 110Q1, 110Qn accordingly. However, unlike the circuit 100 of FIG. 1, only the various sub-circuits 110A, 110B, 110C, 110D0, 110D1, 110Dm, 110Q0, 110Q1, 110Qn are characterized.

In either the method taken in FIG. 1, where the entire circuit 100 is characterized, or in the approach in FIG. 2, where only part of the circuit 100 is characterized, conventional techniques call for the characterization data to be stored in an m×n fixed-dimension format such the format is limited to circuits having no more than m D-type pins and no more than n Q-type pins. If the circuit 100 has more than m D-type pins or more than n Q-type pins, the format is inadequate. Even if the format is adequate for the circuit 100, the circuit 100 may be very large and may have a great amount of redundancy.

FIG. 3 is a flow diagram of one embodiment of a method of characterizing an entire circuit. The method begins in a step 305 in which a standard header is placed into an empty data file that eventually will contain the model. In a step 310, a first sub-circuit is selected as a current cell. In a step 315, the current cell is characterized on all of its inputs and outputs. In a step 320, characterization data pertaining to the current cell is added to the data file.

In a decisional step 325, it is determined whether or not the current cell is the last sub-circuit in the circuit to be characterized. If so, the data file is closed in a step 330, and the model is complete and generated. If not, it is determined in a decisional step 335 whether or not the data file size is at least equal to a predetermined size limit. If so, the data file is closed in a step 340, but the model is incomplete and not generated. If not, it is determined in a decisional step 345 whether or not the runtime is at least equal to a predetermined time limit. If so, the data file is closed in the step 340, but the model is incomplete and not generated. If not, another sub-circuit is selected to be the current cell, and the step 315 and subsequent steps are repeated for the current cell. As the method indicates, the step 315 and subsequent steps are repeated for each sub-circuit in the circuit. Assuming the predetermined size and time limits are not exceeded, a complete data file representing the model is generated in the step 330.

Depending upon the dimensions of the circuit being characterized, the method of FIG. 3 can consume a large amount of processor run-time. With particularly large circuits, the method of FIG. 3 may not even be practicable. With the method of FIG. 3, all the I/O pins of interest, namely A, B, C, D0 . . . Dm and Q0 . . . Qn are characterized, and data is stored in the data file for each of these I/O pins. The resulting data file can be relatively large, rigid and unable to be extended to circuits of differing size, even though the circuit type is the same.

FIG. 4 is a flow diagram of one embodiment of a method of characterizing the input/output pins of interest of a circuit. The method begins in a step 405 in which a standard header is placed into an empty data file that eventually will contain the model. In a step 410, a first sub-circuit is selected as a current cell. In a decisional step 415, it determined whether or not the current cell has any I/O pins. If so, a smaller sub-circuit associated with one of the I/O pins is selected in lieu of the overall sub-circuit itself in a step 420. That smaller sub-circuit is selected as the current cell in a step 425. The current cell is then characterized on all of its inputs and outputs in a step 435. In a step 440, characterization data pertaining to the current cell is added to the data file.

In a decisional step 445, it is determined whether or not the current cell is the last sub-circuit in the circuit to be characterized. If so, the data file is closed in a step 450, and the model is complete and generated. If not, it is determined in a decisional step 455 whether or not the data file size is at least equal to a predetermined size limit. If so, the data file is closed in a step 460, but the model is incomplete and not generated. If not, it is determined in a decisional step 465 whether or not the runtime is at least equal to a predetermined time limit. If so, the data file is closed in the step 460, but the model is incomplete and not generated. If not, another smaller sub-circuit is selected to be the current cell in a step 430, and the step 435 and subsequent steps are repeated for the current cell. As the method indicates, the step 435 and subsequent steps are repeated for each sub-circuit in the circuit. Assuming the predetermined size and time limits are not exceeded, a complete data file representing the model is generated in the step 450.

As is apparent, the method of FIG. 4 involves smaller sub-circuits around each I/O pin. If each sub-circuit is, for example, characterized in terms of noise (e.g., crosstalk) effect, I-V data is needed for each output pin. Each of the curves is dependent on the last channel-connected component (CCC, defined as a transistor connected through its source and drain) driving the output pin (see, e.g., Douglas, et al., “Algorithms for the Reduction of the Number of Points Required to Represent a Digitized Line or Its Caricature,” The Canadian Cartographer, 1973, British Machine Vision Conference). In one embodiment, after extracting the driving CCC of the output pin, a worst-case input pattern is obtained which gives the maximum resistance as this data is used to model the weak victim driver. In one specific embodiment, I-V data is obtained only for this input pattern.

If each sub-circuit is, for example, characterized in terms of static noise margin (SNM) and/or dynamic noise margin (DNM), data is needed for each input pin. The accuracy of that data is dependent on the size of the sub-circuit extracted, subject to the expense of run-time. In one embodiment, two levels of CCCs are extracted to optimize between accuracy and runtime. After extracting the smaller sub-circuits associated with each I/O pin, characterization is done for the smaller sub-circuits.

In the methods of FIGS. 3 and 4, only representative unique sub-circuits from the original circuit are characterized. The number of unique sub-circuits is typically far less than the total number of sub-circuits. Each representative unique sub-circuit has unique I/O pins and represents all such sub-circuits. In the case of regular circuits (e.g., memory blocks), each representative unique sub-circuit represents a relatively large number of other sub-circuits.

FIG. 5 is a schematic representation of an example of characterized unique circuits and pins that together constitute a model of a circuit. In the example of FIG. 1, only the sub-circuits associated with pins A, B, C, one of the D-type pins (e.g., D0) and one of the Q-type pins (e.g., Q0) are characterized (i.e., the sub-circuits 110A, 110B, 110C, 110D0 and 110Q0). Only the data resulting from the characterization of these pins is stored in the model. When needed, the characterization data for the D-type and Q-type pins can be expanded into appropriate dimensions m and n, respectively (e.g., to accommodate different input or output bus widths). As is apparent in FIG. 5, the sub-circuits are smaller than the circuit as a whole, and only a relatively small number of representative unique sub-circuits and unique pins of the circuit as a whole are characterized to obtain the desired information. Furthermore, the data is stored in an expandable format, which will be described later.

FIG. 6 is a flow diagram of another embodiment of a method of characterizing the input/output pins of interest of a circuit. The method begins in a step 605 in which a standard header is placed into an empty data file that eventually will contain the model. In a step 610, a first sub-circuit is selected as a current cell. In a decisional step 615, it determined whether or not the current cell has any I/O pins. If so, in a decisional step 620 it is determined whether the current cell is already represented in the model. If the current cell not already represented, the current sub-circuit is identified as a new representative in a step 625. Then smaller sub-circuit associated with one of the I/O pins is selected in lieu of the overall sub-circuit itself in a step 630. That smaller sub-circuit is selected as the current cell in a step 635. Referring back to the decisional step 620, if the current cell is already represented in the model, the next sub-circuit is selected as the current cell. The current cell is then characterized on all of its inputs and outputs in a step 645. In a step 650, characterization data pertaining to the current cell is added to the data file.

In a decisional step 655, it is determined whether or not the current cell is the last sub-circuit in the circuit to be characterized. If so, the data file is closed in a step 655, and the model is complete and generated. If not, it is determined in a decisional step 665 whether or not the data file size is at least equal to a predetermined size limit. If so, the data file is closed in a step 670, but the model is incomplete and not generated. If not, it is determined in a decisional step 675 whether or not the runtime is at least equal to a predetermined time limit. If so, the data file is closed in the step 670, but the model is incomplete and not generated. If not, another smaller sub-circuit is selected to be the current cell in a step 640, and the step 645 and subsequent steps are repeated for the current cell. As the method indicates, the step 645 and subsequent steps are repeated for each sub-circuit in the circuit. Assuming the predetermined size and time limits are not exceeded, a complete data file representing the model is generated in the step 660.

Once data is obtained for representative, unique sub-circuits and pins and included in the model, the same data can then be used for other sub-circuits and pins. Having described various embodiments by which data for only representative, unique sub-circuits and pins can be obtained and placed in an expandable model and data format, a method of employing such a model and format to characterize a circuit of different dimension will now be set forth. Accordingly, FIG. 7 is a flow diagram of one embodiment of a method of using a parameterized model and format, contained in a data file now called “F0,” to create one or more models, to be contained in one or more corresponding data files now called “Fn,” for one or more additional circuits of the same type but not of the same dimension.

The method begins in a step 705 in which a circuit of type T and having a given number M of sub-circuits of specified types T1, T2, . . . , TM are provided as an input. In a step 710, a standard header is placed into an empty data file, Fn, that eventually will contain the model describing one of the one or more additional circuits. In a step 715, the data file F0 is read and placed into the data file as an initial model for the circuit of type T. Then, in a step 720, a current sub-circuit type is set to T1. Next, the data file Fn containing the model is expanded for each occurrence of the current sub-circuit and corresponding pin in the circuit of type T by copying corresponding data from the data file F0.

In a decisional step 730, it is determined whether or not the current sub-circuit type is the last sub-circuit in the circuit type T. If so, the data file is closed in a step 735, and the model is complete and generated. If not, it is determined in a decisional step 740 whether or not the data file size is at least equal to a predetermined size limit. If so, the data file is closed in a step 745, but the model is incomplete and not generated. If not, another sub-circuit is selected to be the current sub-circuit in a step 750, and the step 725 and subsequent steps are repeated for the current sub-circuit. As the method indicates, the step 725 and subsequent steps are repeated for each sub-circuit in the circuit of type I. Assuming the predetermined size limit is not exceeded, a complete data file representing the model is generated in the step 735.

Similar extracted sub-circuits can not only be explored in parallel pin paths like address pins and data pins, can also be explored across the memory types belonging to the same group. For example, memory blocks can assume many different configurations, such having or not having built-in self-test (BIST) capability or having or not having asynchronous write-through. Those skilled in the pertinent art will understand that many other variations are possible. Nonetheless, in all the configurations, circuits associated with pins having the same functionality will have the same circuit structure.

As is apparent, the method of FIG. 7 employs an expanded data file for each circuit of differing dimension. This typical involves additional processing and memory to generate and accommodate the data file. One embodiment of the method instead employs a modified EDA tool that is able to work directly with the data file F0. For example, such a tool directly and repeatedly extracts the data needed for sub-circuits and pins of a circuit of any dimensionality from the data file F0 rather than require a different data file for that circuit.

Having described methods of generating and expanding data files, an example format of a data file will now be described. The example format is set forth in the context of a memory block. As stated above, memory blocks have regular structures for some pins, such as address and data pins. As discussed earlier, only representative (unique) pins (one of each address, D-type and Q-type pins) is characterized, and the same data is replicated for the remaining pins. To indicate this, wild characters will be used in the example format to denote the scalability of the format to any memory size, e.g., A[0:*], DI[0:*] and DO[0:*]. With this representation, only one model is sufficient to represent a memory block independent of, e.g., address and data bus widths. In one embodiment, multiple dimension arrays, such as DMA1[0:*] [0:*], are supported.

Table 1, below, illustrates an example of a data format pertaining to a TYPE of memory block called “40 nm_example.” This type of memory can have numerous different size configurations, and the different size is represented by “*” in the following model. As a result, this small format contains enough data for all legal instantiations of this TYPE of memory cells in a particular design. In one embodiment, the instance-specific model is constructed while performing other analyses, e.g., crosstalk analysis.

TABLE 1
Example of Data Format for a Memory Block

```
.macro 40nm_example
#Creator MemoryChar
#COMPLIB = ts45_example
#COMPVER = a10p1
#ADS_VERSION fs6.0/tools/40nm_1.0
#Technology = tsmc_cln40g
#Case = wcf
#Temp = 125
#R_UNIT OHM
#V_UNIT V
#VDD Nominal 0.99
VDD=0.99
INPUT RMENA, vr=45, vf=49, gra=6.844e−04, grm=2.162, grvo=0.451,
  vf=49, gfa=9.707e−04, gfm=2.031, gfvo=0.494
INPUT RMENB, vr=45, vf=4 9, gra=6.844e−04, grm=2.162, grvo=0.451,
  vf=49, gfa=9.707e−04, gfm=2.031, gfvo=0.494
INPUT CKA, vr=45, vf=49, gra=6.844e−04, grm=2.162, grvo=0.451,
  vf=49, gfa=9.707e−04, gfm=2.031, gfvo=0.494
INPUT CSA, vr=45, vf=49, gra=6.844e−04, grm=2.162, grvo=0.451,
  vf=49, gfa=9.707e−04, gfm=2.031, gfvo=0.494
INPUT WEA, vr=45, vf=49, gra=6.844e−04, grm=2.162, grvo=0.451,
  vf=49, gfa=9.7076−04, gfm=2.031, gfvo=0.494
INPUT CKB, vr=45, vf=49, gra=6.844e−04, grm=2.162, grvo=0.451,
  vf=49, gfa=9.707e−04, gfm=2.031, gfvo=0.494
INPUT CSB, vr=45, vf=49, gra=6.844e−04, grm=2.162, grvo=0.451,
  vf=49, gfa=9.707e−04, gfm=2.031, gfvo=0.494
INPUT AA[0:*], vr=45, gra=6.844e−04, grm=2.162, grvo=0.451,
  vf=49, gfa=9.707e−04, gfm=2.031, gfvo=0.494
INPUT RMA[0:*], vr=45, vf=49, gra=6.844e−04, grm=2.162,
  grvo=0.451, vf=49, gfa=9.707e−04, gfm=2.031, gfvo=0.494
INPUT AB[0:*], vr=45, vf=49, gra=6.844e−04, grm=2.162,
  grvo=0.451, vf=49, gfa=9.707e−04, gfm=2.031, gfvo=0.494
INPUT RMB[0:*], vr=45, vf=49, gra=6.844e−04, grm=2.162,
  grvo=0.451, vf=49, gfa=9.707e−04, gfm=2.031, gfvo=0.494
INPUT TEST1A, vr=45, vf=49, gra=6.844e−04, grm=2.162,
  grvo=0.451, vf=49, gfa=9.707e−04, gfm=2.031, gfvo=0.494
INPUT TEST1B, vr=45, vf=49, gra=6.844e−04, grm=2.162,
  grvo=0.451, vf=49, gfa=9.707e−04, gfm=2.031, gfvo=0.494
INPUT DA[0:*], vr=45, vf=49, gra=6.844e−04, grm=2.162,
  grvo=0.451, vf=49, gfa=9.707e−04, gfm=2.031, gfvo=0.494
INPUT LS, vr=45, vf=49, gra=6.844e−04, grm=2.162, grvo=0.451,
  vf=49, gfa=9.707e−04, gfm=2.031, gfvo=0.494
OUTPUT QB[0:*], gndres=305, vddres=410
.endmacro
```

Those skilled in the art to which this application relates will appreciate that other and further additions, deletions, substitutions and modifications may be made to the described embodiments.

What is claimed is:

1. A method of characterizing a regular electronic circuit, comprising:
characterizing fewer than all sub-circuits associated with input and output pins of said circuit to yield data regarding said sub-circuits;
generating a data file containing said data, said data file constituting an expandable parameterized model of said circuit.

2. The method as recited in claim 1 wherein said characterizing comprises characterizing only sub-circuits associated with unique input and output pins of said circuit.

3. The method as recited in claim 1 wherein said data file has a size limit and said generating comprises generating said data file only when a size of said data file complies with said size limit.

4. The method as recited in claim 1 wherein said data file has a runtime limit and said generating comprises generating said data file only when a runtime of said data file complies with said runtime limit.

5. The method as recited in claim 1 wherein said characterizing is carried out one sub-circuit at a time.

6. The method as recited in claim 1 wherein said data file includes a standard header.

7. The method as recited in claim 1 wherein said circuit is a memory block.

8. The method as recited in claim 1 wherein an electronic design automation tool directly extracts data needed for sub-circuits and pins of a circuit of a different dimensionality from said data file.

9. A data file constructed by the method of claim 1.

10. A parameterized model and file format for containing a characterization of an electronic circuit, comprising:
a standard header; and
data pertaining to characterizations of fewer than all sub-circuits associated with input and output pins of said circuit.

11. The parameterized model and file format as recited in claim 10 wherein said data pertains to characterizations of only sub-circuits associated with unique input and output pins of said circuit.

12. The parameterized model and file format as recited in claim 10 wherein a size of said data file complies with a predetermined size limit.

13. The parameterized model and file format as recited in claim 10 wherein said data includes wild characters.

14. The method as recited in claim 10 wherein said circuit is a memory block.

15. A method of using a parameterized model of an electronic circuit to create a model for another electronic circuit, comprising:
placing said parameterized model into a data file for said other circuit; and
adding data to said data file corresponding to additional instances of sub-circuits characterized in said parameterized model and present in said other circuit.

16. The method as recited in claim 15 wherein said data file has a size limit and said adding comprises adding said data file only when a size of said data file complies with said size limit.

17. The method as recited in claim 15 wherein said characterizing is carried out one sub-circuit at a time.

18. The method as recited in claim 15 wherein said data file includes a standard header.

19. The method as recited in claim 15 wherein said circuit is a memory block.

20. The method as recited in claim 15 wherein an electronic design automation tool carries out said placing and adding.
